(19) United States
(12) Patent Application Publication
(10) Pub. No.: US 2009/0035635 A1
(43) Pub. Date: Feb. 5, 2009

(54) Combination Structure Between Single Cell and Interconnect of Solid Oxide Fuel Cell

(75) Inventors: Joongmyeon Bae, Daejeon (KR); Changbo Lee, Daejeon (KR)

Correspondence Address: THE WEBB LAW FIRM, P.C., 700 KOPPERS BUILDING, 436 SEVENTH AVENUE, PITTSBURGH, PA, 15219, US

(73) Assignee: KOREA ADVANCED INSTITUTE OF SCIENCE AND TECHNOLOGY, Daejeon (KR)

(21) Appl. No.: 11/942,481

(22) Filed: Nov. 19, 2007

(30) Foreign Application Priority Data
Jul. 30, 2007 (KR) 10-2007-0076133

(51) Int. Cl. H01M 8/10

(52) U.S. Cl. 429/30

(57) ABSTRACT

The present invention relates to a combination structure of a solid oxide fuel cell between an electrode and an interconnect in which the electrode and interconnect are sinter-joined to each other by using slurry in a status that a conventional current collector is excluded, thereby improving a strength and a sealing efficiency. The combination structure between a single cell and an interconnect of a solid oxide fuel cell which comprises electrolyte, and an anode and a cathode which are respectively contacted with both sides of the electrolyte; and an interconnect which are formed at both sides of the single cell and has a cathode passage for supplying air to the cathode and an anode passage for supplying fuel to the anode, is characterized by that one or both sides of the single cell are directly combined with the interconnect.

### TECHNICAL FIELD

The present invention relates to a combination structure between a single cell and an interconnect of solid oxide fuel cell, and more particularly, to a combination structure between a single cell and an interconnect of solid oxide fuel cell in which the electrode and interconnect are sinter-joined to each other by using slurry in a status that a conventional current collector is excluded, thereby improving a strength and a sealing efficiency.

### BACKGROUND ART

A fuel cell, which directly converts chemical energy into electrical energy, is a new green futuristic energy technology which can generates the electrical energy from materials such as oxygen, hydrogen and the like which is found in abundance on the earth.

In the fuel cell, oxygen is supplied to a cathode and hydrogen is supplied to an anode so that an electrochemical reaction is performed in a reverse way of water electrolysis so as to generate electricity, heat and water, thereby producing the electrical energy without any contaminants.

Since the fuel cell is free from limitation of Carnot cycle efficiency which acts as the limitation in a conventional heat engine, it is possible to increase an efficiency of 40% or more. Further, since only the water is exhausted as emissions, there is not a risk of environmental pollution. Furthermore, since, unlike in the conventional heat engine, there is not a necessity of a place for mechanical motion, it has some advantages of reducing a size and a noise. Therefore, the fuel cell technologies (e.g. material, fabrication, etc) are actively investigated at many famous laboratories all over the world at present.

According to a kind of electrolyte used therein, the fuel cell is classified into a PAFC (Phosphoric Acid Fuel Cell), a MCFC (Molten Carbonate Fuel Cell), a SOFC (Solid Oxide Fuel Cell), a PEMFC (Polymer Electrolyte Membrane Fuel Cell), a DMFC (Direct Methanol Fuel Cell) and an AFC (Alkaline Fuel Cell) which are already being used or developed. Characteristics thereof will be described in a table.

| | PAFC | MCFC | SOFC | PEMFC | DMFC | AFC |
|---|---|---|---|---|---|---|
| Electrolyte | Phosphoric | Lithium | Zirconia/ | Hydrogen | Hydrogen | Potassium |
| | acid | carbonate/ | Ceria | ion | ion | hydroxide |
| | | Potassium | series | exchange | exchange | |
| | | carbonate | | membrane | membrane | |
| Ion | Hydrogen ion | Carbonic | Oxygen | Hydrogen | Hydrogen | Hydrogen |
| conductor | | acid ion | ion | ion | ion | ion |
| Operation | 200 | 650 | 500~1000 | <100 | <100 | <100 |
| temperature | | | | | | |
| Fuel | Hydrogen | Hydrogen, | Hydrogen, | Hydrogen | methanol | Hydrogen |
| | | carbon | hydrocarbon, | | | |
| | | monoxide | carbon | | | |
| | | | monoxide | | | |
| Raw | City gas, | City gas, | City gas, | Hydrogen | methanol | Hydrogen |
| material of | LPG | LPG, coal | LPG, | | | |
| fuel | | | Hydrogen | | | |
| Efficiency | 40 | 45 | 45 | 45 | 30 | 40 |
| (%) | | | | | | |
| Range of | 100-5000 | 1000-1000000 | 100-100000 | 1-10000 | 1-100 | 1-100 |
| output | | | | | | |
| power (W) | | | | | | |
| Application | Distributed | Large | Small, | Power | Portable | Power |
| | power | scale | middle | source | power | source for |
| | generation | power | and large | for | source | space ship |
| | | generation | scale | transport | | |
| | | | power | | | |
| | | | generation | | | |
| Development | Demonstrated- | Tested- | Tested- | Tested- | Tested- | Applied to |
| level | utilized | demonstrated | demonstrated | demonstrated | demonstrated | space ship |

As described in the table, the fuel cells have various ranges of output power and applications and the like. Thus, a user can selectively use one of the fuel cells for various purposes. Particularly, in the SOFC, it is easy to control positioning of the electrolyte. Further, since a position of the electrolyte is fixed, there is no a risk that the electrolyte is dried up. Furthermore, it has a long life span due to weak corrosiveness. Therefore, the SOFC is widely used for distributed power generation, commercial and domestic purposes and the like.

In the operation principle of SOFC, when oxygen is supplied to the cathode and hydrogen is supplied to the anode, the reaction is performed as follows:

Reaction in the anode:

2H₂+2O²⁻→2H₂O+4e⁻

Reaction in the cathode:

O₂+4e⁻→2O²⁻

In general, the SOFC uses YSZ (yttria-stabilized zirconia) as the electrolyte, Ni-YSZ cermet as the anode, perovskite material as the cathode and oxygen ions as the electrolytic ion.

Meanwhile, since the fuel cell can not obtain a sufficient voltage with only a single cell, a stacking of single cells should be introduced. FIG. 1 shows a stack structure of the SOFC 1. Herein, a current generated from the fuel cell stack is proportional to a surface area of the cell and a voltage is proportional to the number of stacked cells. The anode 20 and the cathode 30 are disposed around the electrolyte 10, and a cathode current collector 41 and an anode current collector 42, through which gas is uniformly supplied to an inside of each electrode and also electrons can be moved, are respectively coupled to an outside of each electrode 20, 30. The single cells in the stack is divided by an interconnect 50, and the interconnect 50 also functions as oxygen and fuel supplying passages 51, 52. The fuel cell stack is firmly supported by an end plate 60 and a coupling member 70.

FIG. 2 is an enlarged view showing the unit cell, composed of the single cell and interconnect, of the conventional SOFC. The current collector made of an alloy or a noble metal is disposed around the single cell 2 including the electrolyte 10, the anode 20 and the cathode 30, and then airtightly sealed by the interconnect 50. Since the fuel cell is a device for generating power with supplied gas, a considerably high level of sealing technology is required. The hydrogen and oxygen should be flowed through the predetermined passages and also should not be mixed with each other or leaked to the outside. A sealing member 80 is typically formed of a glass-based material but may be formed of various materials according to an operation temperature of the fuel cell.

The SOFC is capable of filling the various requirements in various aspects such as power output characteristic, long-term operation characteristic, thermal cycle characteristic and so on. However, the problems of sealing and mechanical strength are not yet solved. That is, the sealing is a difficult work because of the combination of the ceramic components each other and this makes it difficult to increase an efficiency of fabrication and operation, and the mechanical strength is weak and it may be damaged even by thermally dynamic operation or small external shock. In order to solve the above problems, there have been developed various types of metal-supported SOFCs which are fabricated by a method which coats ceramic components on a porous or pin-holed metallic support, a method in which a porous metal support is semi-sintered and then the ceramic components are coated and sintered on the semi-sintered metal simultaneously, a method in which the ceramic components and metal powder are monolithically sintered by using a powder metallurgy method

However, the metal-supported SOFC also has a difficulty in the aspects of a scale up issue and a fabricating cost due to a characteristic of the fabricating method thereof. Particularly, the current collector 40 is disposed between the single cell 2 and the interconnect 50 so as to improve electrical property, but since the current collector 40 has a certain shape, there is a structural limitation in increasing current collecting property and sealing efficiency.

### DISCLOSURE OF THE INVENTION

It is an object of the present invention to provide a combination structure of a solid oxide fuel cell between an electrode and an interconnect which can considerably increase a structural and mechanical strength, a sealing efficiency and productivity of a fuel cell stack with keeping a role of the current collection.

To achieve the object, there is provided a combination structure between a single cell 2000 and an interconnect 500 of a solid oxide fuel cell 1000 which comprises electrolyte 100, and an anode 200 and a cathode 300 which are respectively contacted with both sides of the electrolyte 100; and an interconnect 500 which are formed at both sides of the single cell 2000 and has a cathode 510 for supplying air to the cathode 300 and an anode passage 520 for supplying fuel to the anode 200, wherein one or both sides of the single cell 2000 are directly combined with the interconnect 500.

Further, the single cell 2000 and the interconnect 500 of the solid oxide fuel cell 1000 are combined by using slurry as an adhesive 900 and then sintered.

Further, the slurry has a porous and electrically conductive property, and the slurry is a mixture of a metal, ceramic, or cermet, and the adhesive 900 is a cermet adhesive in which tiny amounts of NiO/YSZ and ferrite-based metal are mixed.

Furthermore, the sintering is performed at a temperature of 1300 to 1500° C. after putting the single cell 1000 on the adhesive-coated interconnect 500.

In addition, the interconnect 500 is a metallic support having a metallic property.

And the fuel cell 1000 is layered in a stack type.

Further, the unit cell 100 is a metallic support.

According to the present invention, the single cell and the interconnect of the SOFC is combined by excluding the conventional current collector and using the slurry as an adhesive, thereby improving the sealing efficiency therebetween and also considerably increasing the mechanical strength of the fuel cell stack.

### BRIEF DESCRIPTION OF THE DRAWINGS

FIG. 1 is a schematic diagram showing a stack structure of a conventional SOFC.

FIG. 2 is an enlarged view of a unit cell of the conventional SOFC.

FIG. 3 is a side sectional view showing a combination structure between a unit cell and an interconnect of a SOFC according to the present invention.

FIG. 4 is a photograph showing a unit cell of a metal supported SOFC and a SEM image.

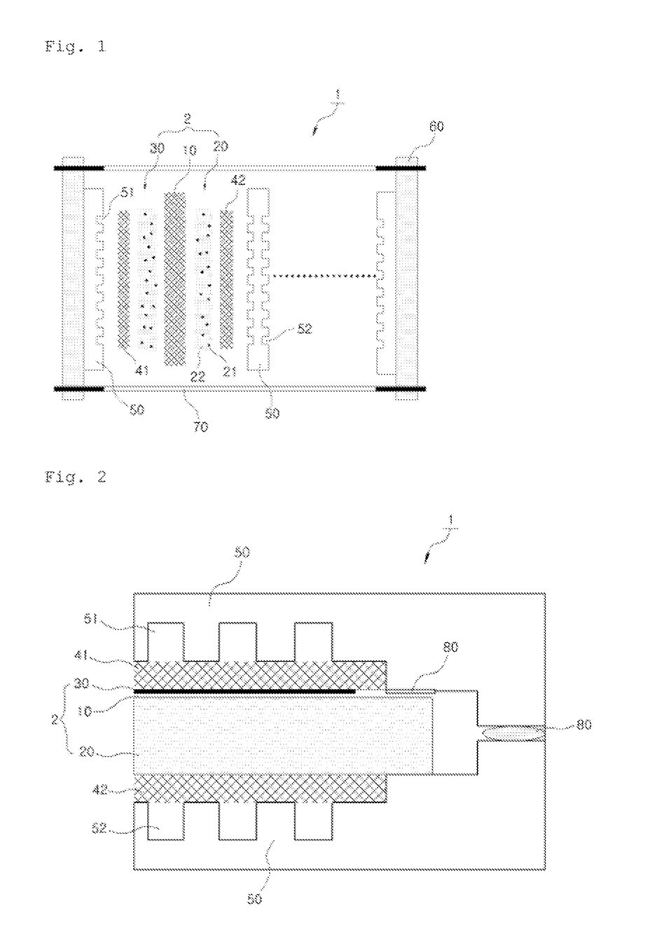

### DETAILED DESCRIPTION OF MAIN ELEMENTS

| | | | |
|---|---|---|---|
| 1000: | fuel cell | | |
| 2000: | unit cell (electrolyte, anode, cathode) | | |
| 100: | electrolyte | 200: | anode |
| 300: | cathode | 400: | current collector |
| 410: | cathode current collector | | |
| 500: | interconnect | 600: | end plate |
| 700: | coupling member | 800: | sealant |
| 900: | adhesive | | |

### BEST MODE FOR CARRYING OUT THE INVENTION

Practical and presently preferred embodiments of the present invention are illustrative with reference to the accompanied drawings.

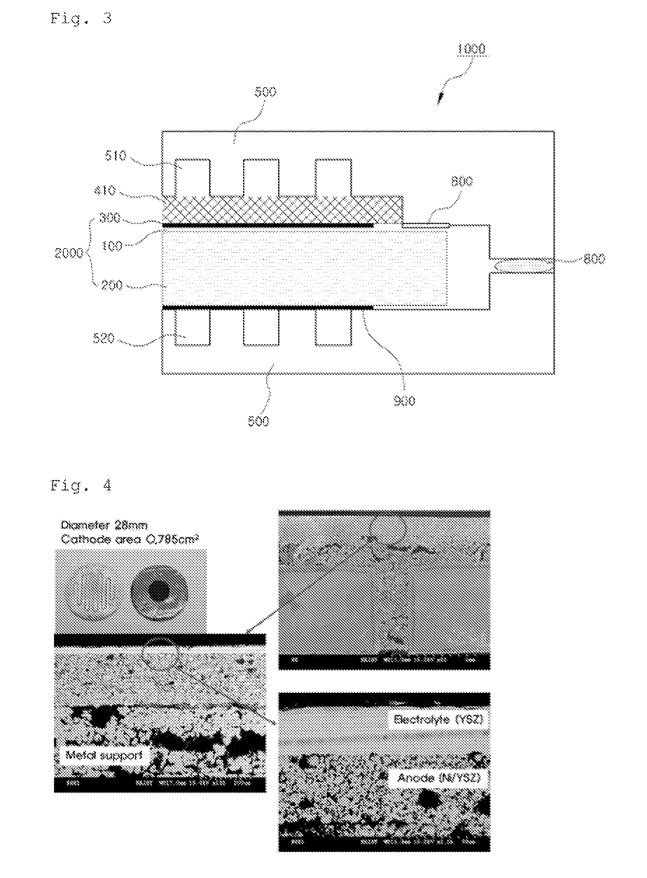

FIG. 3 is a side sectional view showing a combination structure between a single cell and an interconnect of a SOFC according to the present invention, which is correspondent with FIG. 2 for convenience of explanation.

However, it will be appreciated that those skilled in the art, on consideration of this disclosure, may make modifications and improvements within the spirit and scope of the present invention.

According to a combination structure between a single cell 2000 and an interconnect 500 of a solid oxide fuel cell (SOFC) 1000 of the present invention, the SOFC 100 includes the single cell 2000 having electrolyte 100 and an anode 200 and a cathode 300 which are respectively contacted with both sides of the electrolyte 100; and an interconnect 500 which are formed at both sides of the single cell 2000 and has a cathode passage 510 for supplying air to the cathode 300 and an anode passage 520 for supplying fuel to the anode 200. In the SOFC 1000, one or both sides of the single cell 2000 are directly combined with the interconnect 500.

That is, in the combination structure between the electrodes 200 and 300 and the interconnect of the SOFC 1000, the single cell 200 is directly combined with the interconnect in a status of excluding a current collector 400.

Herein, one or both sides of the single cell 200 mean the cathode 300 or the anode 200, or both of the cathode 300 and the anode 200.

The single cell 2000 and interconnect 500 can be combined by a sintering method using slurry as an adhesive 900. According to the present invention, the combining may be performed by other physical or chemical method.

In a case that the slurry is used as the adhesive 900, the slurry as the adhesive 900 has a property of a metal and/or ceramic, preferably, the slurry has a porous conductive property so that the fuel supplied through the anode passage 520 can be flowed.

In the combination structure between the single cell 2000 and the interconnect 500 of the SOFC 1000 of the present invention shown in FIG. 3, the cathode passage 510 of the upper interconnect 500 is contacted with the cathode current collector 410, and the single cell 2000 is disposed beneath the cathode current collector 410. The single cell 2000 is comprised of the electrolyte 100, the cathode 300 and the anode 200, and also combined with the lower interconnect 500 by the adhesive 900. The lower interconnect 500 is formed with the anode passage 520 and thus fuel gas can be supplied through it. Since the adhesive 900 has the porous property, it has a function of uniformly dispersing the supplied fuel to the anode 200 and facilely exhausting generated water as well as an inherent function of electrically connecting the anode 200 and the interconnect 500. A sealant 800 is interposed between the electrolyte 100 and the interconnect 500 and between the upper and lower interconnects 500.

FIG. 3 shows an example in which the lower interconnect 500 is directly combined with the anode 200 by the adhesive 900, and the cathode current collector 410 is provided between the cathode 300 and the upper interconnect 500. This structure can be achieved reversely. In a status that the current collector 410 is excluded, the interconnect 500 may be directly combined with each of the anode 200 and the cathode 300.

Therefore, the combination structure between the single cell 2000 and the interconnect 500 of the SOFC 1000 has advantages of further reinforcing the mechanical strength and solving the sealing and current collecting efficiency problem generated by using the conventional current collector.

Hereinafter, a method of fabricating the fuel cell stack according to the present invention will be fully described. The ceramic elements of anode 200 and the electrolyte 100 are stacked by using a tape casting process. It is preferable that YSZ (Tosoh TZ-8Y) is used as the electrolyte 100, and NiO and YSZ (Tosoh TZ-8Y) is mixed in a ratio of 6:4 and used as the anode 200. Slurry for the tape casting is obtained by mixing Butvar B-98 as binder of 15% weight, polyvinylpyrrolidone as dispersant of 2% weight, polyethylene glycol as plasticizer of 10% weight and S-NECS as a solvent of 100% weight with respect to each powder and then ball-milling for 48 hours. After de-airing the slurry, a ceramic sheet is secured by using a tape caster having a height of 150 μm or 250 μm. And the stacking process is performed according to the application and then the sintering is performed for 4 hours at a temperature of 1500° C. so as to obtain the dense electrolyte 100 and ceramic aggregate of the anode 200 having some pores. A circular STS430 plate having a diameter of 28 mm and a thickness of 1 mm is used as a metallic support for the interconnect 500. The passage 520 having a width of 0.4 mm is formed at the metal plate. A cermet adhesive 900 in which tiny amounts of NiO/YSZ and ferrite-based metal are mixed is coated on the interconnect 500, and the electrolyte 100 and the ceramic aggregate of the anode 200 are provided thereon and then sintered for about 10 hours at a temperature of 1400° C. so as to secure a metal supported unit cell 2000. As shown in FIG. 3, the current collector 400 interposed between the anode 200 and the interconnect 500 is replaced with the adhesive 900.

FIG. 4 shows a photograph showing a unit cell 2000 of a metal supported SOFC 1000 and a SEM image. The YSZ electrolyte 100 has a thickness of about 30 μm, the anode 200 is about 200 μm and the interconnect 500 as a porous metallic support is 400 μm. La_{0.8}Sr_{0.2}Co_{0.4}Mn_{0.6}O₃ (LSCM-8246) having a lower resistance against the electrolyte is used as the cathode 300.

In the embodiment of the present invention, there is provided a sintering method using the slurry as an adhesive 900 for combining the single cell 2000 and the interconnect 500. Furthermore, there may be also provided other physical or chemical methods which use the porous adhesive 900 having a proper thermal and electrical property.

In the combination structure of the present invention, the fuel cell stack has an excellent mechanical strength. The electrode 200 and the interconnect 500 are combined by excluding the current collector 400 which is lack of structural stability and which is not of help to reinforce the entire strength of the stack but by using the adhesive 900 which has porosity, conductivity and water repellency, thereby improving the mechanical strength and the sealing efficiency and also providing excellent properties in the aspects of the large surface area and the fabricating cost.

### INDUSTRIAL APPLICABILITY

The SOFC employing the combination structure between the electrode and the interconnect is formed into a stack shape, thereby being used in various fields of Distributed power generation, commercial and domestic purposes and the like.

Those skilled in the art will appreciate that the conceptions and specific embodiments disclosed in the foregoing description may be readily utilized as a basis for modifying or designing other embodiments for carrying out the same purposes of the present invention. Those skilled in the art will also appreciate that such equivalent embodiments do not depart from the spirit and scope of the invention as set forth in the appended claims.

1. A combination structure between a single cell and an interconnect of a solid oxide fuel cell, comprising: an electrolyte, an anode and a cathode which are respectively contacted with both sides of the electrolyte, and an interconnect which are formed at both sides of the single cell and has a cathode passage for supplying air to the cathode and an anode passage for supplying fuel to the anode, wherein one or both sides of the single cell are directly combined with the interconnect.

2. The combination structure as set forth in claim 1, wherein the single cell and the interconnect of the solid oxide fuel cell are combined by using slurry as an adhesive and then sintered.

3. The combination structure as set forth in claim 2, wherein the slurry has a porous and electrically conductive property.

4. The combination structure as set forth in claim 2, wherein the slurry is a mixture of a metal, ceramic, or metal and ceramic (cermet).

5. The combination structure as set forth in claim 2, wherein the adhesive is a ce net adhesive in which tiny amounts of NiO/YSZ and ferrite-based metal are mixed.

6. The combination structure as set forth in claim 2, wherein the sintering is performed at a temperature of to 1500° C. after putting the single cell on the adhesive-coated interconnect.

7. The combination structure as set forth in claim 1, wherein the interconnect is a metallic support having a metallic property.

8. The combination structure as set forth in claim 1, wherein the fuel cell is layered in a stack type.

9. The combination structure as set forth in claim 8, wherein the single cell is a metallic support.

10. The combination structure as set forth in claim 2, wherein the interconnect is a metallic support having a metallic property.

11. The combination structure as set forth in claim 3, wherein the interconnect is a metallic support having a metallic property.

12. The combination structure as set forth in claim 4, wherein the interconnect is a metallic support having a metallic property.

13. The combination structure as set forth in claim 5, wherein the interconnect is a metallic support having a metallic property.

14. The combination structure as set forth in claim 6, wherein the interconnect is a metallic support having a metallic property.

15. The combination structure as set forth in claim 2, wherein the fuel cell is layered in a stack type.

16. The combination structure as set forth in claim 3, wherein the fuel cell is layered in a stack type.

17. The combination structure as set forth in claim 4, wherein the fuel cell is layered in a stack type.

18. The combination structure as set forth in claim 5, wherein the fuel cell is layered in a stack type.

19. The combination structure as set forth in claim 6, wherein the fuel cell is layered in a stack type.
